(19) United States
(12) Patent Application Publication
(10) Pub. No.: US 2007/0041873 A1
(43) Pub. Date: Feb. 22, 2007

(54) Analyzer having fluid storage and injection mechanism and vibration mixer

(75) Inventor: Yi-Lung Lee, Taichung County (TW)

Correspondence Address: BACON & THOMAS, PLLC, 625 SLATERS LANE, FOURTH FLOOR, ALEXANDRIA, VA, 22314, US

(73) Assignee: TERA AUTOTECH CORPORATION, TAICHUNG HSIEN (TW)

(21) Appl. No.: 11/326,319

(22) Filed: Jan. 6, 2006

(30) Foreign Application Priority Data
Aug. 19, 2005 (TW) 94128551

(51) Int. Cl. G01N 21/00; B01J 19/18

(52) U.S. Cl. 422/64; 422/136

(57) ABSTRACT

An analyzer includes a vibration mixer having a carrier for holding solutions or reagents for mixing, a first motion unit for reciprocally moving the carrier in a first direction, and a second motion unit for reciprocally moving the carrier in a second direction perpendicular to the first direction, and a fluid storage and injection mechanism supported on the vibration mixer. The fluid storage and injection mechanism includes a rotary table, a driving member for rotating the rotary table, and a plurality of storage and injection units fastened spacedly to the rotary table. Each storage and injection unit has a storage tank for holding a fluid and an actuating member mounted in the storage tank and movable reciprocally in the storage chamber for forcing the contained fluid out of the storage tank upon movement of the respective storage and injection unit with the rotary table to a predetermined position.

### BACKGROUND OF THE INVENTION

1. Field of the Invention

The present invention relates generally to analyzers that can examine multiple properties of a fluid/reagent under test simultaneously, and more specifically to such an analyzer that comprises a fluid storage and injection mechanism and a vibration mixer for vibrating the fluid storage and injection mechanism in different directions to well mix various fluids/reagents carried in the fluid storage and injection mechanism.

2. Description of the Related Art

When wishing to mix different solutions or regents in a laboratory for analysis in an analyzer, the solutions or reagents are poured in different wells in a container, and then the container is set in the analyzer and vibrated by the analyzer through a vibration procedure. According to conventional analyzers, the vibration procedure is to reciprocate the container in one direction. Therefore, it takes much time to uniformly mix the solution or reagent.

Further, when wishing to mix different fluids to form a finished product in a conventional analyzer, it is achieved manually by taking each prepared fluid from the respective storage tank to a mixing tank and then vibrating the mixing tank to mix the added fluids into the desired mixture. Transferring different fluids from different storage tanks to a mixing tank by labor takes much time. An analyzer is known comprising a plurality of storage tanks for holding different fluids, and a movable syringe for picking up the contained fluid from each selected storage tank and injecting the received fluid into a mixing tank. After each injection operation, a cleaning fluid is guided into the movable syringe, and then the movable syringe is moved to a collector tank and operated to discharge the cleaning fluid into the collector tank. After this cleaning cycle, the movable syringe is moved to a next storage tank for picking up another fluid. This fluid transferring and syringe cleaning procedure is complicated, wasting much time.

### SUMMARY OF THE INVENTION

The present invention has been accomplished under the circumstances in view. It is one object of the present invention to provide an analyzer, which uses a vibration mixer that vibrates on a plane in all directions to accelerate the mixing of fluids.

It is another object of the present invention to provide an analyzer, which improves fluid mixing efficiency before analysis.

It is another object of the present invention to provide an analyzer, which has a simple structure and is practical in use.

To achieve these objects of the present invention, the analyzer comprises a base, a vibration mixture mounted on the base, and a fluid storage and injection mechanism supported above the vibration mixer. The vibration mixer comprises a first motion unit, a second motion unit, and a carrier. The first motion unit has a first rail and a second rail arranged in parallel and extending in a first direction, a sliding device coupled to and movable along the first and second rails of the first motion unit, and a drive coupled to the sliding device of the first motion unit for reciprocally moving the sliding device of first motion unit in the first direction. The second motion unit has a first rail and a second rail arranged in parallel and extending in a second direction perpendicular to the first direction and defining with the first and second rails of the first motion unit a motion zone, a sliding device coupled to and movable along the first and second rails of the second motion unit, and a drive coupled to the sliding device of the second motion unit for reciprocally moving the sliding device of the second motion unit in the second direction perpendicular to the first direction. The carrier is slidably coupled to the sliding device of the first motion unit and the sliding device of the second motion unit, and movable by the first motion unit and the second motion unit on a plane within the motion zone. The fluid storage and injection mechanism has a rotary table assembly provided with a driving member and a rotary table coupled to the driving member and rotatable by the driving member, and a plurality of storage and injection units each having a storage tank fastened to a periphery of the rotary table, and an actuating member. The storage tank has a storage chamber for holding a fluid and an injection hole at a bottom side of the storage chamber, and the actuating member is mounted in the storage chamber of the storage tank and movable reciprocally in the storage chamber for forcing the contained fluid out of the storage chamber through the injection hole upon movement of the respective storage and injection unit with the rotary table to a predetermined position.

### BRIEF DESCRIPTION OF THE DRAWINGS

FIG. 1 is a schematic top view of an analyzer according to a preferred embodiment of the present invention.

FIG. 2 is a schematic side view of the analyzer according to the preferred embodiment of the present invention.

FIG. 3 is a schematic top view of the fluid storage and injection mechanism of the analyzer according to the preferred embodiment of the present invention.

FIG. 4 is a schematic side view of the fluid storage and injection mechanism of the analyzer according to the preferred embodiment of the present invention.

FIG. 5 is a schematic top view of the vibration mixer of the analyzer according to the preferred embodiment of the present invention.

FIGS. 6 and 7 are schematic drawings showing the operation of the vibration mixer of the analyzer according to the preferred embodiment of the present invention.

### DETAILED DESCRIPTION OF THE INVENTION

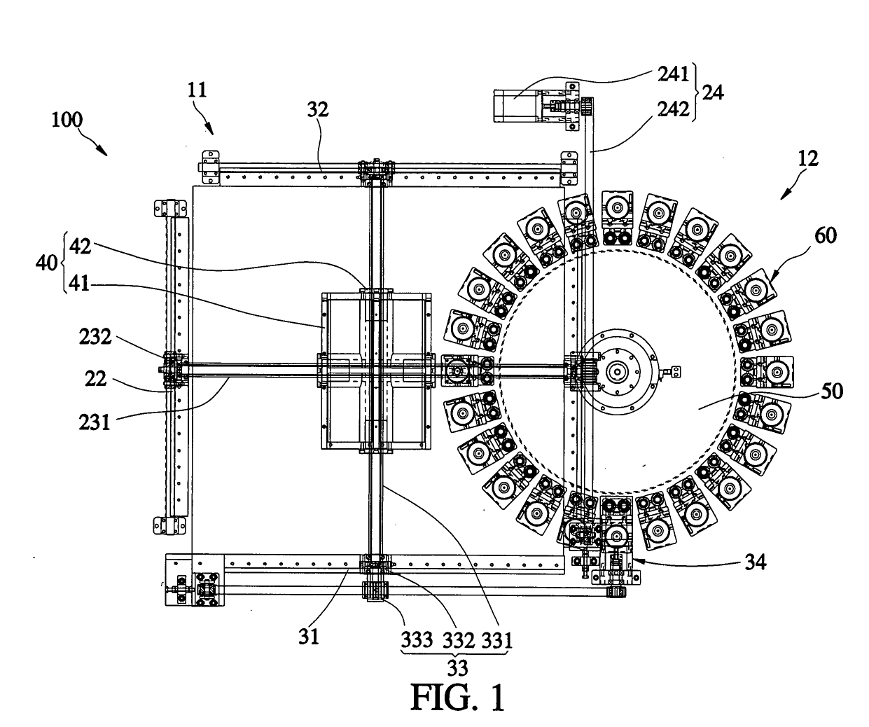

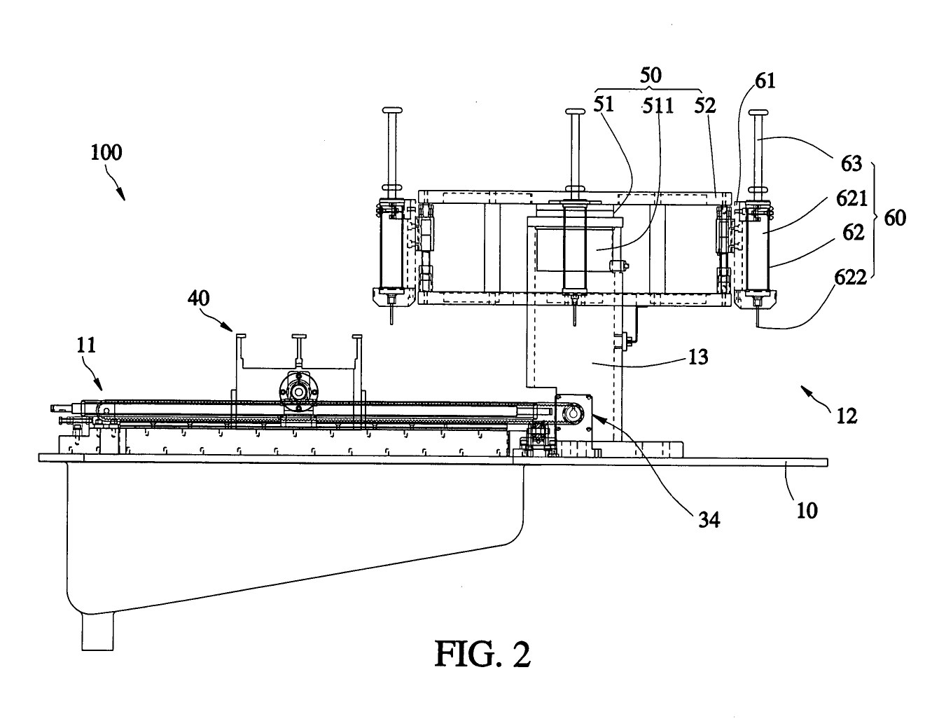

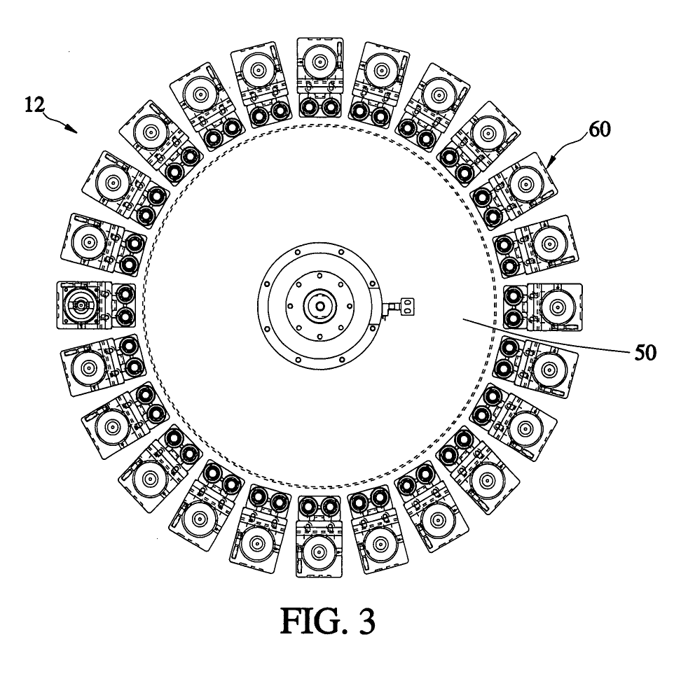

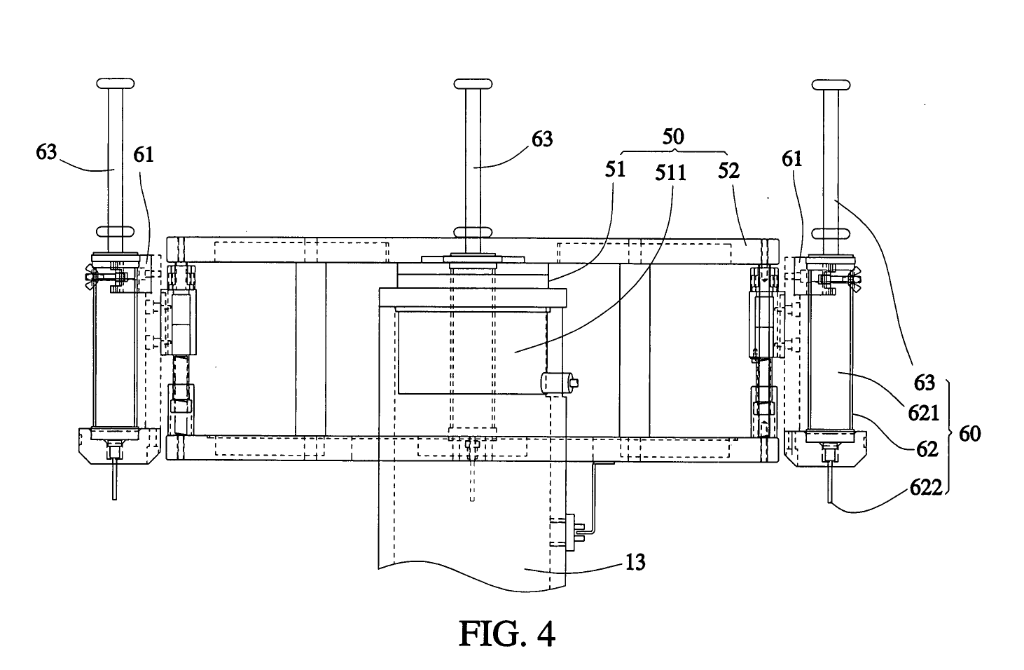

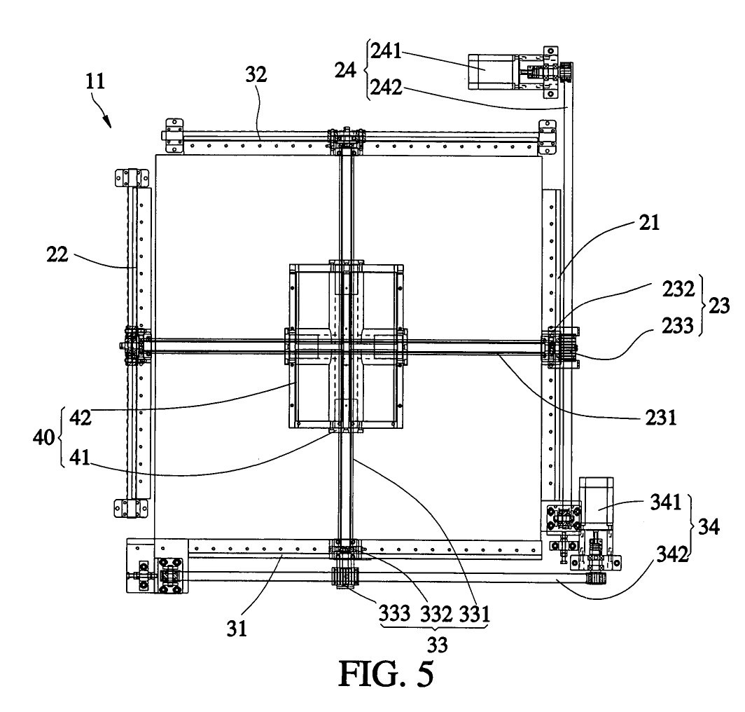

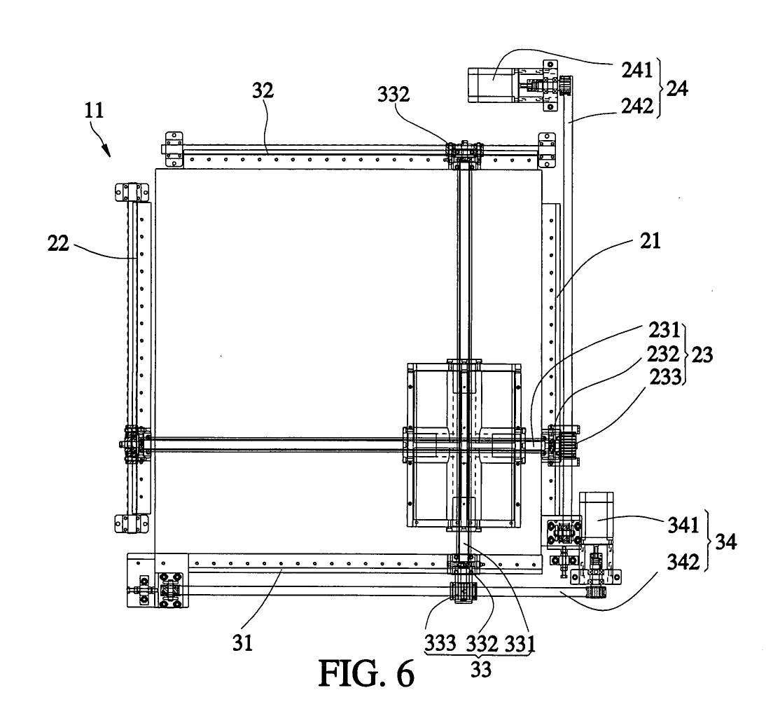

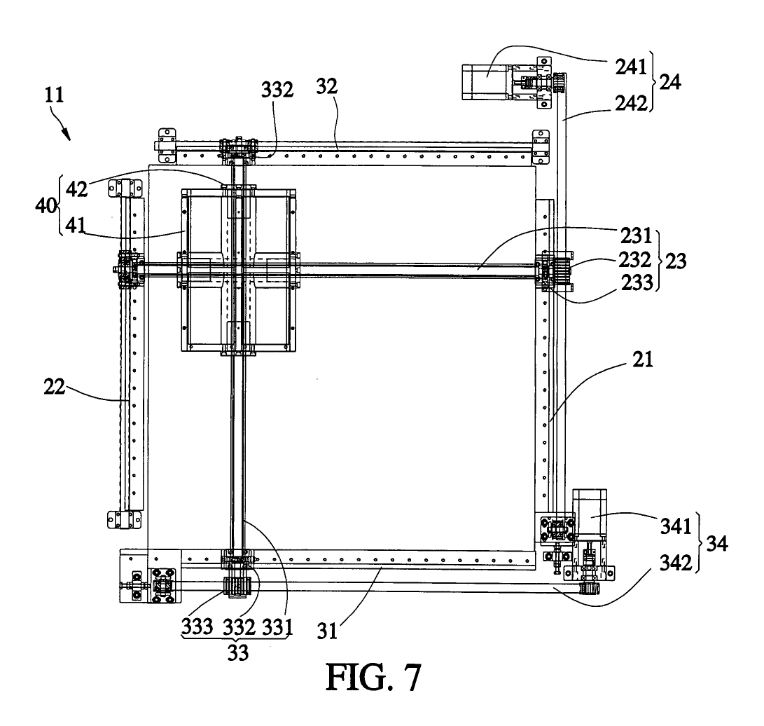

Referring to FIGS. 1-7, an analyzer 100 in accordance with the preferred embodiment of the present invention is shown comprising a base frame 10, a vibration mixer 11, and a fluid storage and injection mechanism 12.

As shown in FIGS. 1-5, the vibration mixer 11 is mounted on the base frame 10, comprising a first motion unit 20, a second motion unit 30, and a carrier 40.

The first motion unit 20 comprises a first rail 21, a second rail 22, a sliding device 23, and a drive 24.

The first rail 21 and the second rail 22 are arranged in parallel on the base frame 10, and spaced from each other at a predetermined distance. The sliding device 23 comprises a link 231, two connectors 232, and a driven member 233. The link 231 is coupled to the first rail 21 and the second rail 22 and extending in direction perpendicular to the extending direction of the rails 21, 22, having two distal ends respectively extending over the rails 21, 22. The two connectors 232 are respectively fixedly fastened to the two ends of the link 231 and respectively slidably coupled to the first rail 21 and the second rail 22 to hold the link 231 between the rails 21, 22, for enabling the link 231 to be reciprocated by an external force along the rails 21, 22 in a first direction, namely, the X-axis direction. The driven member 233 according to this embodiment is a gear pivoted to one of the two connectors 232.

The drive 24 comprises a motor 241 and a transmission rod 242. The transmission rod 242 according to this embodiment is a screw rod disposed at an outer side relative to the first rail 21 in a parallel manner and meshed with the driven member 233. The motor 241 is a servomotor, having a pinion (not shown) fixedly mounted on the output shaft thereof and meshed with the transmission rod 242. Upon operation of the motor 241, the transmission rod 242 is rotated to move the driven member 233, thereby causing the sliding device 23 to be moved along the rails 21, 22. By means of controlling forward/backward rotation of the motor 241, the sliding device 23 is driven to move reciprocally.

The second motion unit 30 comprises a first rail 31, a second rail 32, a sliding device 33, and a drive 34.

The first rail 31 and the second rail 32 are arranged in parallel on the base frame 10, and spaced from each other at a predetermined distance. Further, the rails 31, 32 of the second motion unit 30 and the rails 21, 22 of the first motion unit 20 are arranged at right angles, defining a motion zone. The sliding device 33 comprises a link 331, two connectors 332, and a driven member 333. The link 331 is coupled to the first rail 31 and the second rail 32 and extending in direction perpendicular to the extending direction of the rails 31, 32, having two distal ends respectively extending over the rails 31, 32. The two connectors 332 are respectively fixedly fastened to the two ends of the link 331 and respectively slidably coupled to the first rail 31 and the second rail 32 to hold the link 331 between the rails 31, 32, for enabling the link 331 to be reciprocated by an external force along the rails 31, 32 in a second direction, namely, the Y-axis direction. The driven member 333 according to this embodiment is a gear pivoted to one of the two connectors 332.

The drive 34 comprises a motor 341 and a transmission rod 342. The transmission rod 342 according to this embodiment is a screw rod disposed at an outer side relative to the first rail 31 in a parallel manner and meshed with the driven member 333. The motor 341 is a servomotor, having a pinion (not shown) fixedly mounted on the output shaft thereof and meshed with the transmission rod 342. Upon operation of the motor 341, the transmission rod 342 is rotated to move the driven member 333, thereby causing the sliding device 33 to be moved along the rails 31, 32. By means of controlling forward/backward rotation of the motor 341, the sliding device 33 is driven to move reciprocally.

The carrier 40 is adapted to carry a multi-well container for holding different solutions or reagents for mixing, comprising a flat rectangular carrier base 41 and four sleeves 42 respectively provided at the four sides of the flat rectangular carrier base 41. The four sleeves 42 are arranged in two pairs respectively sleeved onto the links 231, 331 such that the links 231, 331 can move the carrier 40 within the aforesaid motion zone.

Referring to FIGS. 1-4 again, the fluid storage and injection mechanism 12 is supported on a support 13 above the vibration mixer 11. The support 13 has one end fixedly fastened to the base frame 10, and the other end connected to the fluid storage and injection mechanism 12. The fluid storage and injection mechanism 12 comprises a rotary table assembly 50, and a plurality of storage and injection units 60.

The rotary table assembly 50 comprises a driving member 51 and a rotary table 52. The driving member 51 comprises a motor 511. The motor 511 is mounted inside the support 13. The rotary table 52 is shaped like a disc and coupled to the motor 511 of the driving member 51 for synchronous rotation with the motor 511. The periphery of the rotary table 51 is equiangularly divided into a plurality of holder portions.

Each storage and injection unit 60 is comprised of a connecting member 61, a storage tank 62, and an actuating member 63. The connecting member 61 is a bracket fixedly fastened with one end thereof to one holder portion of the rotary table 52 of the rotary table assembly 51. The storage tank 62 is fastened to the connecting member 61 and suspending outside the rotary table 52, defining a storage chamber 621 for holding a fluid, and an injection hole 622 at the bottom side of the storage chamber 621. The actuating member 63 is a piston mounted in the storage chamber 621 of the storage tank 62, and movable forwardly and backwardly in the storage chamber 621. The actuating member 63 is kept in close contact with the inside wall of the storage chamber 621 such that the storage fluid does not flow out of the injection hole 622 when the actuating member 63 does no work.

The operation of the present invention is described hereinafter. After the container that holds prepared solutions or reagents has fastened to the carrier 40, operate the drives 24 and 34 to move the driven member 233 and 333 respectively, causing the link 231 of the first motion unit 20 to be moved in a first direction and the link 331 of the second motion unit 30 to be moved in a second direction. At this time, the carrier 40 is carried by the links 231 and 331 to a predetermined location adjacent to one side of the fluid storage and injection mechanism 12 below one of the storage and injection units 60.

At this time, different prepared fluids are respectively filled in the storage chambers 621 of the storage tanks 62 of the storage and injection unit 60 respectively, and then the driving member 51 is started to rotate the rotary table 52 at a predetermined speed. When one storage and injection unit 60 reached the injection position right above the carrier 40, the actuating member 63 of the respective storage and injection unit 60 is immediately driven by an external force (not shown) to move downwards to force a certain amount of the respective fluid out of the respective storage chamber 621 through the respective injection hole 622 into the container at the carrier 40, and then another storage and injection unit 60 can be moved, if desire, by the rotation of the rotary table 51 to reach the injection position right above the container at the carrier 40 for further injection process, and then the injection process can be repeated again and again subject to the user's requirement. When the injection processes are completed, the drives 24 and 34 are operated to move the sliding device 23 in the first direction and the sliding device 33 in the second direction. After movement of the drives 24 and 34 in clockwise direction through a predefined period, the drives 24 and 34 can be moved in counter-clockwise direction. These clockwise and counter-clockwise movements can be alternatively performed, causing the fluids or reagents contained in the container to be well mixed.

As indicated above, the invention provides an analyzer in which the vibration mixer 11 can be oscillated on a plane in different directions to well mix the fluids/reagents carried thereon within a short period. Further, the fluid storage and injection mechanism 12 has a plurality of storage and injection units 60 for storing and dispensing many different fluids/reagents, improving the working efficiency.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An analyzer comprising:
a base;
a vibration mixer mounted on said base, said vibration mixer having a first motion unit, a second motion unit, and a carrier;
wherein said first motion unit has a first rail and a second rail arranged in parallel and extending in a first direction, a sliding device coupled to and movable along the first and second rails of said first motion unit, and a drive coupled to the sliding device of said first motion unit for reciprocally moving the sliding device of said first motion unit in said first direction;
wherein said second motion unit has a first rail and a second rail arranged in parallel and extending in a second direction perpendicular to said first direction and defining with the first and second rails of said first motion unit a motion zone, a sliding device coupled to and movable along the first and second rails of said second motion unit, and a drive coupled to the sliding device of said second motion unit for reciprocally moving the sliding device of said second motion unit in said second direction perpendicular to said first direction;
wherein said carrier is slidably coupled to the sliding device of said first motion unit and the sliding device of said second motion unit and movable by said first motion unit and said second motion unit on a plane within said motion zone; and
a fluid storage and injection mechanism supported above said vibration mixer, said fluid storage and injection mechanism having a rotary table assembly provided with a driving member and a rotary table coupled to said driving member and rotatable by said driving member, and a plurality of storage and injection units each having a storage tank fastened to a periphery of said rotary table, and an actuating member; wherein said storage tank has a storage chamber for holding a fluid and an injection hole at a bottom side of said storage chamber, and the actuating member is mounted in said storage chamber of said storage tank and is movable reciprocally in said storage chamber for forcing the contained fluid out of said storage chamber through said injection hole upon movement of the respective storage and injection unit with said rotary table to a predetermined position.

2. The analyzer as claimed in claim 1, wherein the sliding device of said first motion unit comprises a link inserted through said carrier and coupled to the first rail and second rail of said first motion unit and extending in direction perpendicular to the extending direction of the first and second rails of said first motion unit, the link of said first motion unit having two distal ends thereof respectively extending over the rails of said first motion unit, two connectors respectively fixedly fastened to the two ends of the link of said first motion unit and respectively pivoted to the first rail and second rail of said first motion unit to hold the link of said first motion unit between the first rail and second rail of said first motion unit and for enabling the link of said first motion unit to be reciprocally moved along the first and second rails of said first motion unit, and a driven member coupled to the drive of said first motion unit and movable by the drive of said first motion unit to drive the link of said first motion unit to move said carrier.

3. The analyzer as claimed in claim 1, wherein the sliding device of said second motion unit comprises a link inserted through said carrier and coupled to the first rail and second rail of said second motion unit and extending in direction perpendicular to the extending direction of the first and second rails of said second motion unit, the link of said second motion unit having two distal ends thereof respectively extending over the first and second rails of said second motion unit, two connectors respectively fixedly fastened to the two ends of the link of said second motion unit and respectively pivoted to the first rail and second rail of said second motion unit to hold the link of said second motion unit between the first rail and second rail of said second motion unit and for enabling the link of said second motion unit to be reciprocally moved along the first and second rails of said second motion unit, and a driven member coupled to the drive of said second motion unit and movable by the drive of said second motion unit to drive the link of said second motion unit to move said carrier.

4. The analyzer as claimed in claim 1, wherein the drive of said first motion unit comprises a transmission rod disposed at an outer side relative to the first rail of said first motion unit in a parallel manner and meshed with said first motion unit, and a motor coupled to the transmission rod of said first motion unit for rotating the transmission rod of said first motion unit to further move the sliding device of said first motion unit along the first rail and second rail of said first motion unit.

5. The analyzer as claimed in claim 1, wherein the drive of said second motion unit comprises a transmission rod disposed at an outer side relative to the first rail of said second motion unit in a parallel manner and meshed with said second motion unit, and a motor coupled to the transmission rod of said second motion unit for rotating the transmission rod of said second motion unit to further move the sliding device of said second motion unit along the first rail and second rail of said second motion unit.

6. The analyzer as claimed in claim 1, wherein said carrier is adapted to carry a multi-well container for holding different solutions or reagents for mixing.

7. The analyzer as claimed in claim 1, wherein said carrier comprises a base and four sleeves respectively provided at said base for insertion of said first motion unit and said second motion unit for enabling said carrier to be moved by said first motion unit and said second motion unit within said motion zone.

8. The analyzer as claimed in claim 1, wherein said driving member of said rotary table assembly comprises a motor mounted on a support at said vibration mixer for rotating said rotary table relative to said vibration mixer.

9. The analyzer as claimed in claim 1, wherein said rotary table is shaped like a disc coupled to said driving member of said rotary table assembly, having the periphery thereof divided into a plurality of holder portions for holding said storage and injection units respectively.

10. The analyzer as claimed in claim 1, wherein said storage and injection units each have a connecting member which is a bracket for connecting the respective storage tank to said rotary table.

11. The analyzer as claimed in claim 1, wherein said actuating member is a piston peripherally stopped against an inside wall of the respective storage tank.

12. The analyzer as claimed in claim 1, wherein said fluid storage and injection mechanism is supported on a support at said vibration mixer.

13. An analyzer comprising:
a base;
a vibration mixer mounted on said base, said vibration mixer comprising a first motion unit, a second motion unit, and a carrier, said first motion unit and said second motion unit being arranged perpendicularly and defining a motion zone, said carrier being slidably coupled to said first motion unit and said second motion unit and movable by said first motion unit and said second motion unit on a plane within said motion zone; and
a fluid storage and injection mechanism supported above said vibration mixer, said fluid storage and injection mechanism comprising a plurality of storage and injection units, said storage and injection units each comprising a storage tank having a storage chamber for holding a fluid and an injection hole at a bottom side of said storage chamber, and an actuating member mounted in said storage chamber of said storage tank and movable reciprocally in said storage chamber for forcing the contained fluid out of said storage chamber through said injection hole upon movement of the respective storage and injection unit with said rotary table to a predetermined position.

14. The analyzer as claimed in claim 13, wherein said carrier is adapted to carry a multi-well container for holding different solutions or reagents for mixing.

15. The analyzer as claimed in claim 13, wherein said fluid storage and injection mechanism further comprises a rotary table assembly for carrying said storage and injection units, said rotary table assembly comprising a driving member and a rotary table coupled to said driving member and rotatable by said driving member; wherein said fluid storage and injection units are mounted to a periphery of the rotary table.

16. An analyzer comprising:
a vibration mixer having at least one motion unit, and a carrier coupled to said at least one motion unit and movable by said at least one motion unit on a plane; and
a fluid storage and injection mechanism supported above said vibration mixer, said fluid storage and injection mechanism comprising at least one storage and injection unit having a storage tank with a storage chamber for holding a fluid and an injection hole at a bottom side of said storage chamber, and an actuating member mounted in said storage chamber of said storage tank and movable reciprocally in said storage chamber for forcing the contained fluid out of said storage chamber through said injection hole.
